(19) United States
(12) Patent Application Publication
(10) Pub. No.: US 2026/0128942 A1
(43) Pub. Date: May 7, 2026

(54) METHOD FOR OPERATING CORE NETWORK FOR OVERCOMING CORE NETWORK FAILURE PROBLEM IN 5G WIRELESS COMMUNICATION SYSTEM

(71) Applicant: LG ELECTRONICS INC., Seoul (KR)

(72) Inventors: Seungjong YUK, Seoul (KR); Hoyeon RYU, Seoul (KR)

(73) Assignee: LG ELECTRONICS INC., Seoul (KR)

(21) Appl. No.: 19/117,888

(22) PCT Filed: Oct. 5, 2023
(86) PCT No.: PCT/KR2023/015321

§ 371 Date: Apr. 2, 2025

(30) Foreign Application Priority Data
Oct. 5, 2022 (KR) 10-2022-0127320

(51) Int. Cl. H04L 41/0663; H04W 76/30

(52) U.S. Cl. CPC H04L 41/0663; H04W 76/30

(57) ABSTRACT

In one embodiment, a method for operating a first network function (NF) related to a failure of a second network function (NF) in a wireless communication system comprises: the first NF recognizing the failure of the second NF; and on the basis of the first NF recognizing the failure of the second NF, transmitting information indicating a status of the second NF to an access and mobility management function (AMF), wherein the information indicating the status of the second NF triggers a user equipment (UE) context release command transmitted by the AMF to a base station.

### TECHNICAL FIELD

The following description relates to a wireless communication system, and more specifically, to a CORE N/W method and apparatus for overcoming a failover problem in a 5G SA redundancy/single CORE communication network.

### BACKGROUND ART

A wireless communication system uses various radio access technologies (RATs) such as long term evolution (LTE), LTE-advanced (LTE-A), and wireless fidelity (WiFi). 5th generation (5G) is such a wireless communication system. Three key requirement areas of 5G include (1) enhanced mobile broadband (eMBB), (2) massive machine type communication (mMTC), and (3) ultra-reliable and low latency communications (URLLC). Some use cases may require multiple dimensions for optimization, while others may focus only on one key performance indicator (KPI). 5G supports such diverse use cases in a flexible and reliable way.

eMBB goes far beyond basic mobile Internet access and covers rich interactive work, media and entertainment applications in the cloud or augmented reality (AR). Data is one of the key drivers for 5G and in the 5G era, we may for the first time see no dedicated voice service. In 5G, voice is expected to be handled as an application program, simply using data connectivity provided by a communication system. The main drivers for an increased traffic volume are the increase in the size of content and the number of applications requiring high data rates. Streaming services (audio and video), interactive video, and mobile Internet connectivity will continue to be used more broadly as more devices connect to the Internet. Many of these applications require always-on connectivity to push real time information and notifications to users. Cloud storage and applications are rapidly increasing for mobile communication platforms. This is applicable for both work and entertainment. Cloud storage is one particular use case driving the growth of uplink data rates. 5G will also be used for remote work in the cloud which, when done with tactile interfaces, requires much lower end-to-end latencies in order to maintain a good user experience. Entertainment, for example, cloud gaming and video streaming, is another key driver for the increasing need for mobile broadband capacity. Entertainment will be very essential on smart phones and tablets everywhere, including high mobility environments such as trains, cars and airplanes. Another use case is augmented reality (AR) for entertainment and information search, which requires very low latencies and significant instant data volumes.

One of the most expected 5G use cases is the functionality of actively connecting embedded sensors in every field, that is, mMTC. It is expected that there will be 20.4 billion potential Internet of things (IoT) devices by 2020. In industrial IoT, 5G is one of areas that play key roles in enabling smart city, asset tracking, smart utility, agriculture, and security infrastructure.

URLLC includes services which will transform industries with ultra-reliable/available, low latency links such as remote control of critical infrastructure and self-driving vehicles. The level of reliability and latency are vital to smart-grid control, industrial automation, robotics, drone control and coordination, and so on.

Now, multiple use cases will be described in detail.

5G may complement fiber-to-the home (FTTH) and cable-based broadband (or data-over-cable service interface specifications (DOCSIS)) as a means of providing streams at data rates of hundreds of megabits per second to giga bits per second. Such a high speed is required for TV broadcasts at or above a resolution of 4K (6K, 8K, and higher) as well as virtual reality (VR) and AR. VR and AR applications mostly include immersive sport games. A special network configuration may be required for a specific application program. For VR games, for example, game companies may have to integrate a core server with an edge network server of a network operator in order to minimize latency.

The automotive sector is expected to be a very important new driver for 5G, with many use cases for mobile communications for vehicles. For example, entertainment for passengers requires simultaneous high capacity and high mobility mobile broadband, because future users will expect to continue their good quality connection independent of their location and speed. Other use cases for the automotive sector are AR dashboards. These display overlay information on top of what a driver is seeing through the front window, identifying objects in the dark and telling the driver about the distances and movements of the objects. In the future, wireless modules will enable communication between vehicles themselves, information exchange between vehicles and supporting infrastructure and between vehicles and other connected devices (e.g., those carried by pedestrians). Safety systems may guide drivers on alternative courses of action to allow them to drive more safely and lower the risks of accidents. The next stage will be remote-controlled or self-driving vehicles. These require very reliable, very fast communication between different self-driving vehicles and between vehicles and infrastructure. In the future, self-driving vehicles will execute all driving activities, while drivers are focusing on traffic abnormality elusive to the vehicles themselves. The technical requirements for self-driving vehicles call for ultra-low latencies and ultra-high reliability, increasing traffic safety to levels humans cannot achieve.

Smart cities and smart homes, often referred to as smart society, will be embedded with dense wireless sensor networks. Distributed networks of intelligent sensors will identify conditions for cost- and energy-efficient maintenance of the city or home. A similar setup can be done for each home, where temperature sensors, window and heating controllers, burglar alarms, and home appliances are all connected wirelessly. Many of these sensors are typically characterized by low data rate, low power, and low cost, but for example, real time high definition (HD) video may be required in some types of devices for surveillance.

The consumption and distribution of energy, including heat or gas, is becoming highly decentralized, creating the need for automated control of a very distributed sensor network. A smart grid interconnects such sensors, using digital information and communications technology to gather and act on information. This information may include information about the behaviors of suppliers and consumers, allowing the smart grid to improve the efficiency, reliability, economics and sustainability of the production and distribution of fuels such as electricity in an automated fashion. A smart grid may be seen as another sensor network with low delays.

The health sector has many applications that may benefit from mobile communications. Communications systems enable telemedicine, which provides clinical health care at a distance. It helps eliminate distance barriers and may improve access to medical services that would often not be consistently available in distant rural communities. It is also used to save lives in critical care and emergency situations. Wireless sensor networks based on mobile communication may provide remote monitoring and sensors for parameters such as heart rate and blood pressure.

Wireless and mobile communications are becoming increasingly important for industrial applications. Wires are expensive to install and maintain, and the possibility of replacing cables with reconfigurable wireless links is a tempting opportunity for many industries. However, achieving this requires that the wireless connection works with a similar delay, reliability and capacity as cables and that its management is simplified. Low delays and very low error probabilities are new requirements that need to be addressed with 5G

Finally, logistics and freight tracking are important use cases for mobile communications that enable the tracking of inventory and packages wherever they are by using location-based information systems. The logistics and freight tracking use cases typically require lower data rates but need wide coverage and reliable location information.

A wireless communication system is a multiple access system that supports communication of multiple users by sharing available system resources (a bandwidth, transmission power, etc.). Examples of multiple access systems include a CDMA system, an FDMA system, a TDMA system, an OFDMA system, an SC-FDMA system, and an MC-FDMA system.

Sidelink (SL) refers to a communication scheme in which a direct link is established between user equipments (UEs) and the UEs directly exchange voice or data without intervention of a base station (BS). SL is considered as a solution of relieving the BS of the constraint of rapidly growing data traffic.

Vehicle-to-everything (V2X) is a communication technology in which a vehicle exchanges information with another vehicle, a pedestrian, and infrastructure by wired/wireless communication. V2X may be categorized into four types: vehicle-to-vehicle (V2V), vehicle-to-infrastructure (V2I), vehicle-to-network (V2N), and vehicle-to-pedestrian (V2P). V2X communication may be provided via a PC5 interface and/or a Uu interface.

As more and more communication devices demand larger communication capacities, there is a need for enhanced mobile broadband communication relative to existing RATs. Accordingly, a communication system is under discussion, for which services or UEs sensitive to reliability and latency are considered. The next-generation RAT in which eMBB, MTC, and URLLC are considered is referred to as new RAT or NR. In NR, V2X communication may also be supported.

### DISCLOSURE

### Technical Tasks

One technical task of the present disclosure is to provide a CORE N/W method and apparatus for overcoming a failover problem of an NF in a 5G SA redundancy/single CORE communication network.

### Technical Solutions

In one technical task of the present disclosure, provided is a method of operating a first Network Function (NF) related to a failover of a second NF in a wireless communication system, the method including recognizing the failover of the second NF by the first NF and based on the first NF recognizing the failover of the second NF, transmitting information indicating a status of the second NF to an Access and Mobility Management Function (AMF), wherein the information indicating the status of the second NF may trigger a User Equipment (UE) context release command transmitted by the AMF to a base station.

In another technical task of the present disclosure, provided is a first Network Function (NF) in a wireless communication system, the first NF including at least one processor and at least one computer memory operatively connected to the at least one processor and storing instructions enabling the at least one processor to perform operations when executed, the operations including recognizing the failover of the second NF by the first NF and based on the first NF recognizing the failover of the second NF, transmitting information indicating a status of the second NF to an Access and Mobility Management Function (AMF), wherein the information indicating the status of the second NF may trigger a User Equipment (UE) context release command transmitted by the AMF to a base station.

In further technical task of the present disclosure, provided is a non-volatile computer-readable storage medium storing at least one computer program including an instruction enabling at least one processor to perform operations for a first NF when executed, the operations including recognizing the failover of the second NF by the first NF and based on the first NF recognizing the failover of the second NF, transmitting information indicating a status of the second NF to an Access and Mobility Management Function (AMF), wherein the information indicating the status of the second NF may trigger a User Equipment (UE) context release command transmitted by the AMF to a base station.

The first NF may recognize the failover of the second NF based on an ID change of the second NF.

The ID change of the second NF may be caused by a restart based on the failover of the second NF.

The first NF may recognize the failover of the second NF based on a heartbeat failover of the second NF.

The heartbeat failure may be that a heartbeat from the second NF is not received within a preset time.

The information indicating the status of the second NF may be an NF status notify message.

The UE context release command may be a UE context releases command message.

The UE context release command may trigger an RRC release message of the base station to the UE.

The UE disconnected from a core network 1 having the AMF belong thereto by the RRC release message may transmit a service request for a connection request to the AMF belonging to the core network 1.

The UE disconnected from a core network 1 having the AMF belong thereto by the RRC release message may transmit a service request for a connection request to an AMF belonging to a core network 2.

The core network 1 and the core network 2 may be related to a redundancy network configuration.

The first NF may be a Network Repository Function (NRF) and wherein the second NF is a UPF or an SMF.

The first NF may be a User Plane Function (UPF) and wherein the second NF is a Session Management Function (SMF).

The first NF may be an SMF and wherein the second NF is a UPF.

### Advantageous Effects

According to one embodiment, when a Network Function (NF) such as SMF/UPF and the like in a single/redundancy network undergoes a failover of Down (Failure/Crash) or a disabled status, there is an advantage in immediately handling it.

### DESCRIPTION OF DRAWINGS

The accompanying drawings, which are included to provide a further understanding of the disclosure and are incorporated in and constitute a part of this application, illustrate embodiment(s) of the disclosure and together with the description serve to explain the principle of the disclosure.

FIG. 1 shows a Non-Roaming 5G System Architecture.

FIG. 2 shows an NRF, d an NRF registration procedure, and the like.

FIG. 3 shows the entire architecture of 5G NR.

FIG. 4 illustrates a basic redundancy server network configuration.

FIG. 5 shows a redundancy connection algorithm and a redundancy N/W transition flow when a failover occurs.

FIGS. 6 to 9 are diagrams for explaining an embodiment.

FIGS. 10 to 12 are diagrams illustrating various devices to which embodiments(s) are applicable.

### BEST MODE

In various embodiments of the present disclosure, “/” and “,” should be interpreted as “and/or”. For example, “A/B” may mean “A and/or B”. Further, “A, B” may mean “A and/or B”. Further, “A/B/C” may mean “at least one of A, B and/or C”. Further, “A, B, C” may mean “at least one of A, B and/or C”.

In various embodiments of the present disclosure, “or” should be interpreted as “and/or”. For example, “A or B” may include “only A”, “only B”, and/or “both A and B”. In other words, “or” should be interpreted as “additionally or alternatively”.

Techniques described herein may be used in various wireless access systems such as code division multiple access (CDMA), frequency division multiple access (FDMA), time division multiple access (TDMA), orthogonal frequency division multiple access (OFDMA), single carrier-frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/Enhanced Data Rates for GSM Evolution (EDGE). OFDMA may be implemented as a radio technology such as IEEE 802.11 (Wi-Fi), IEEE 802.16 (WiMAX), IEEE 802.20, evolved-UTRA (E-UTRA), or the like. IEEE 802.16m is an evolution of IEEE 802.16c, offering backward compatibility with an IRRR 802.16e-based system. UTRA is a part of universal mobile telecommunications system (UMTS). 3rd generation partnership project (3GPP) long term evolution (LTE) is a part of evolved UMTS (E-UMTS) using evolved UTRA (E-UTRA). 3GPP LTE employs OFDMA for downlink (DL) and SC-FDMA for uplink (UL). LTE-advanced (LTE-A) is an evolution of 3GPP LTE.

A successor to LTE-A, 5th generation (5G) new radio access technology (NR) is a new clean-state mobile communication system characterized by high performance, low latency, and high availability. 5G NR may use all available spectral resources including a low frequency band below 1 GHZ, an intermediate frequency band between 1 GHz and 10 GHz, and a high frequency (millimeter) band of 24 GHz or above.

While the following description is given mainly in the context of LTE-A or 5G NR for the clarity of description, the technical idea of an embodiment of the present disclosure is not limited thereto.

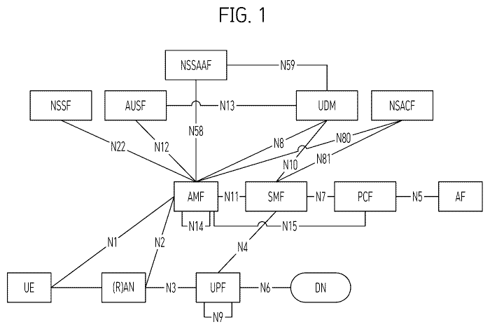

FIG. 1 illustrates a Non-Roaming 5G System Architecture disclosed in 3GPP TS 23.501. As shown, in the 5G Core Network, there are various Network Functions (NFs) such as Access and Mobility Management Function (AMF), User Plane Function (UPF), Session Management Function (SMF), and the like. A network function may be implemented as a network element in dedicated hardware, a software instance running on the dedicated hardware, or a virtualized function instantiated on an appropriate platform. For example, it may be executed in a cloud infrastructure.

Table 1 below shows an NF of the 5G Core Network and functions of the corresponding NF.

TABLE 1

| NF | function |
|---|---|
| AMF (Access | Access and mobility management functions |
| and Mobility | RAN CP interface (N2) termination |
| Management | NAS (N1) termination, NAS encryption, and integrity protection. |
| Function) | Registration management. |
| | Connection management |
| | Accessibility management. |
| | Mobility management. |
| | Legitimate blocking (for interfaces to AMF events and LI systems). |
| | Providing SM message transmission between UE and SMF |
| | Transparent proxy for SM message routing. |
| | Access authentication and access authorization |
| | Providing SMS message transmission between UE and SMSF |
| | SEAF (Security Anchor Function). Interacting with AUSF and UE |
| | and receiving an intermediate key generated as a result of a UE |
| | authentication process. In case of USIM-based authentication, |
| | searching by AMF for security data from AUSF |
| | Function for non-3GPP access networks |
| UPF (User Plane | User plane functions |
| Function) | Anchor point for Intra-/Inter-RAT mobility, if applicable. |
| | External PDU session point of interconnection to data network |
| | Routing and forwarding packets |
| | packet inspection |
| | User plane portion of the policy rule enforcement (e.g., gating, |
| | redirection, traffic coordination). |
| | Legitimate blocking (UP collection). |
| | Traffic use amount report. |
| | QoS processing for user plane (e.g. UL/DL rate application, |
| | reflective QoS display of DL). |
| | Uplink traffic verification (from SDF to QoS flow mapping). |
| | Marking transmission-level packets on uplink and downlink. |
| | Downlink packet buffering and downlink data notification |
| | triggering. |
| | Send and forward one or more “end markers” to the source NG- |
| | RAN node |
| SMF (Session | Session Management Functions |
| Management | UE IP address assignment and management; |
| Function) | Select and control UP function; |
| | Configure traffic coordination in UPF to route traffic to an |
| | appropriate target |
| | Control policy enforcement and some of QoS |
| | Downlink data notification. |
| PCF (Policy | Policy Control Functions |
| Control | Supports a unified policy framework for managing network |
| Function) | operations |
| | Enforce by providing policy rules to control plane function |
| | Access subscription information related to policy decisions in |
| | Unified Data Repository (UDR) |
| UDM (Unified | Unified Data Management |
| Data | Generating 3GPP AKA authentication credentials. |
| Management) | User identification processing |
| | Grant access authority based on subscription data (for example, |
| | roaming restriction). |
| | Management of UE's serving NF registration |
| | Support service/session continuity, e.g., maintain SMF/DNN |
| | allocation of an ongoing session |
| | MT-SMS delivery support. |
| | Legitimate blocking function |
| | Subscriptions management. |
| | SMS management. |
| AUSF(Authentication | Support AUSF(Authentication Server Function) designated in SA |
| Server | WG3 |
| Function) | |
| AF (Application | Application influence on traffic routing |
| Function) | Network exposure function access |
| | Interaction with policy frameworks for policy control |

In addition, there are various reference points such as N2, N3, and N4, which mean interfaces between different functions or nodes in the network architecture.

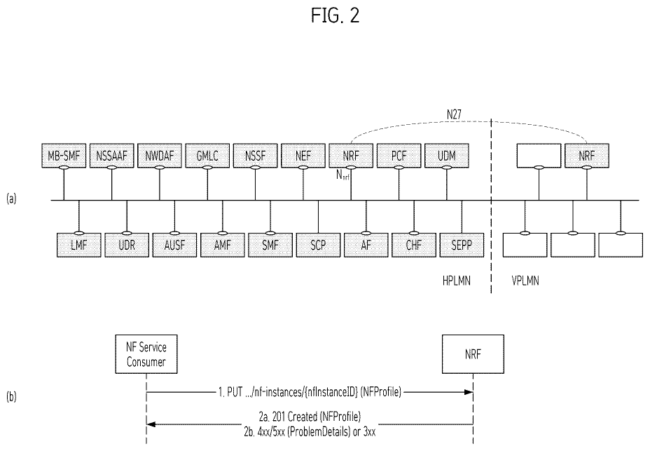

In FIG. 2(a), a Network Repository Function (NRF) is shown. The NRF serves as a central registration center for all core network components. As shown in FIG. 2, the NRF is connected to all 5G core components of an HPLMN and is connected to another NRF of a VPLMN through an N27 interface. The NRF performs registration functions of AMF, AUSF, UDM, UDR, PCF, SMF, NSSF, and BSF, respectively.

In FIG. 2(b), a procedure for registering NFs (NF service consumer) excluding the NRF with the NRF is illustrated. For a detailed procedure related to this, refer to 3GPP TS 29.510.

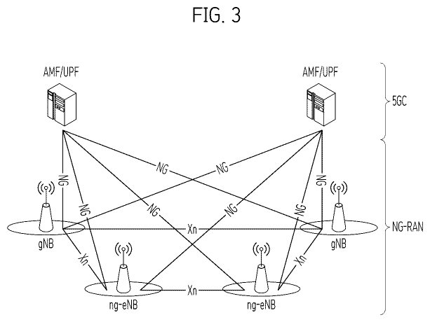

FIG. 3 shows the overall architecture of 5G NR.

A gNB node provides NR User Plane and Control Plane protocol terminations toward the User Equipment (UE) and is connected to the 5G Core network (5GC) through an NG interface.

An ng-eNB node provides E-UTRA User Plane and Control Plane protocol terminations toward the UE and is connected to the 5GC through the NG interface.

As shown, the UE is connected to a base station through an air base station (a gNB or ng-eNB is connected through an air interface).

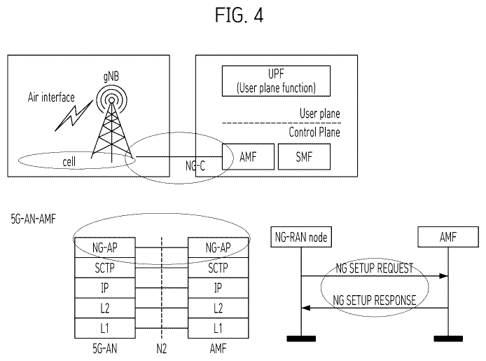

FIG. 4 illustrates a basic redundancy server network configuration. Specifically, FIG. 4 illustrates that the same CORE NW redundancy configuration is provided to RAN (gNB) #1 and two servers #1 and #2. In a core SW layer, an NW switch algorithm may be operated based on 3GPP NG-FLEX SPEC. For information on NG-FLEX, refer to the contents disclosed in TS 23.501 6.3.5/TS 23.501 5.19.3/TS 23.501 5.19.5/TS 38.410/TS 23.501 5.21.2/TS 38.413. RAN and AMF are connected by NG-AP protocol to become NG-SETUP, thereby performing control plane communication. Other SMF/UPF and the like are unable to perform control connection with the RAN.

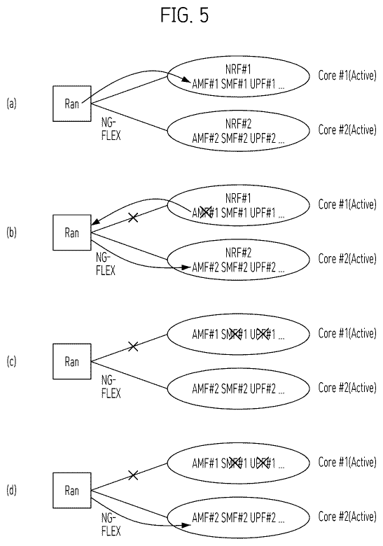

FIG. 5(a) shows a redundancy connection algorithm at a normal flow. Referring to FIG. 5, after a UE is connected to a RAN (after booting), the RAN may simultaneously create a control connection with AMF #1 and AMF #2 through an NG-SETUP connection. When the UE performs a session connection (after booting), a session is connected through one of the two AMFs. FIG. 5 shows that it is connected to Core #1 through AMF #1. That is, in FIG. 5, a session is connected through UE-RAN-CORE #1. Since Core #2 only has a setup connected to the RAN by NG-AP protocol, it corresponds to a state that an actual session is not connected.

FIG. 5(b) shows that a redundancy N/W transition FLOW is shown when a failover occurs. When AMF Down (Failure/Crash) occurs, the NG-SETUP connection with the RAN fails and the RAN makes another CORE NW transition.

However, if SMF #1/UPF #1 of Core #1 undergoes a failover of Down (Failure/Crash) or a disabled status, as shown in FIG. 5(c), as NW processing is not performed, it may occur that both Core #1 and Core #2 are maintained in the disabled status.

In more detail, as described above, RAN and AMF are connected by NG-AP protocol to be NG-SETUP, thereby performing control plane communication. Yet, SMF, UPF, and the like are unable to directly perform control plane communication with RAN. Therefore, even if SMF #1/UPF #1 undergoes a failover of Down (Failure/Crash) or a disabled status, since RAN is unable to know it, the RAN is unable to take measures such as RRC release and the like to the UE. In this case, the UE is unable to perform data transmission and reception and a status in which the UE is unable to make a transition to redundancy N/W, as shown in FIG. 5(d), continues, unlike the case in which AMF Down (Failure/Crash) occurs.

Therefore, in the present disclosure below, a method and apparatus for immediately handling a case in which a Network Function (NF) such as SMF, UPF, or the like in a single/redundancy network undergoes a failover of Down (Failure/Crash) or a disabled status will be described.

In a method of operating a first Network Function (NF) related to a failover of a second NF according to one embodiment, the first NF may recognize the failover of the second NF. The first NF may transmit information notifying a status of the second NF to an Access and Mobility Management Function (AMF) based on recognizing the failover of the second NF.

Here, the information notifying the status of the second NF may be triggering a User Equipment (UE) context release command that the AMF transmits to a base station. The failover means down, failure, crash, malfunction, etc., and means that an NF is unable to perform a normal operation.

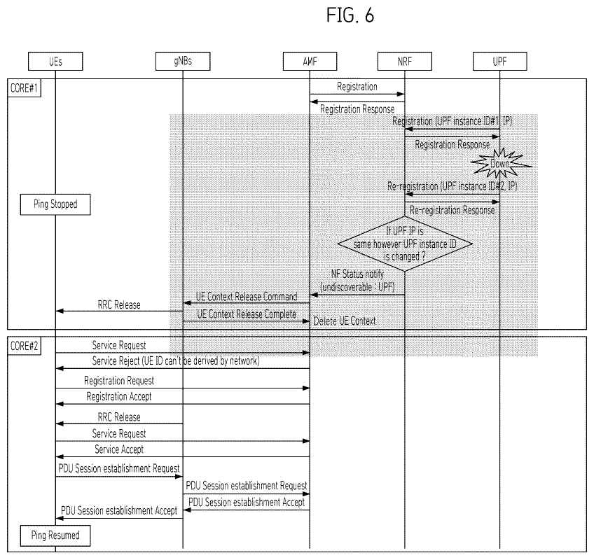

The first NF may recognize the failover of the second NF based on a change in an ID of the second NF. The change in the ID of the second NF may be due to restart based on the failover of the second NF. That is, as shown in FIG. 6, when a failover occurs in the second NF (UPF of FIG. 6), the second NF is automatically restarted to perform re-registration in the NRF, where the ID of the second NF is changed (UPF instance ID #1→UPF instance ID #2). Therefore, through the change in the ID, the first NF (NRF of FIG. 6) may recognize the failover of the second NF (UPF of FIG. 6).

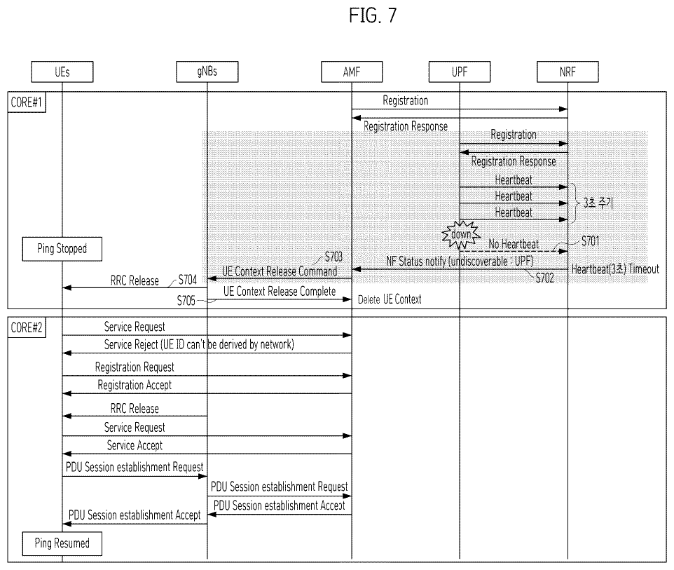

As another example, the first NF may recognize the failover of the second NF (S701 of FIG. 7), based on a heartbeat failure of the second NF. The heartbeat failure may be that a heartbeat from the second NF is not received within a preset time. According to a related art, since the heartbeat is transmitted every 3 seconds, the preset time may be 3 seconds. In addition, an actual heartbeat period may be determined by NW vendors (NW vendor dependent), and thus the heartbeat may be set to this determined value. The information notifying the status of the second NF may be an NF status notify message S702. The message may include information such as an ID for identifying the second NF in which the failover has occurred, a time when the failover has been recognized, a reason, and the like.

The UE context release command may be a UE context release message (S703). That is, an AMF having received the NF status notify message from the first NF may transmit the UE context references command message to the base station. The UE context release command (UE context release command message) may trigger an RRC release message of the base station to the UE. Accordingly, the base station transmits the RRC release message to the UE (S704), and the UE releases the RRC connection.

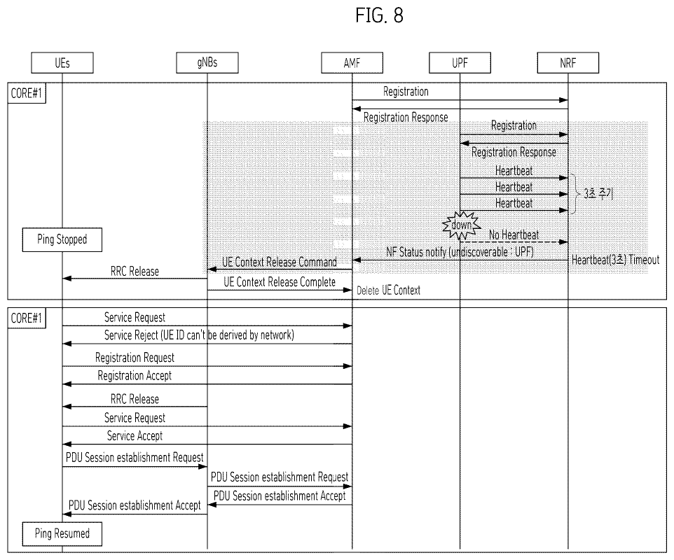

Subsequently, since the RRC connection has been released, the UE may transmit a service request to an AMF. Here, the AMF may be the AMF of Core #2, as illustrated in FIG. 7 for a redundancy (network) configuration. Alternatively, the AMF may be the AMF that has transmitted the UE context releases command, as illustrated in FIG. 8 for a monolithic configuration. That is, the UE disconnected from a core network 1 to which the AMF belongs by the RRC release message may transmit a service request for a connection request to the AMF belonging to the core network 1. In addition, the UE disconnected from the core network 1 to which the AMF belongs by the RRC release message may transmit a service request for a connection request to the AMF belonging to a core network 2. The core network 1 and the core network 2 may correspond to a redundancy network configuration.

Thereafter, the UE receives a service reject from the AMF. This is because in a redundancy configuration, the AMF having received the service request is a new AMF of Core #2, and thus there is no UE context. In the case of a single configuration, the AMF having received the service request is the AMF that transmitted the UE context releases command, but deleted the UE context while transmitting the UE context releases command.

The UE that has received the service reject establishes a PDU session through the registration procedure, as shown in FIG. 7 or FIG. 8.

The first NF is an NRF, and the second NF is a UPF or an SMF. Alternatively, the first NF is an UPF, and the second NF is an SMF. Alternatively, the first NF is an SMF, and the second NF is a UPF. Alternatively, the first NF is an NF having an interface with an AMF, and the second NF is an NF having an interface with the first NF. Since a function of the NRF is a very simple NF interworking control function in a 5G network, there is little possibility of failover occurrence compared to the SMF/UPF, and thus it may be advantageous to perform an operation of detecting a failover of NF such as SMF, UPF, etc. and notifying the AMF of the failover detection.

In the above description, a first Network Function (NF) may include at least one processor; and at least one computer memory operatively connected to the at least one processor and storing instructions enabling the at least one processor to perform operations when executed. The operations may include recognizing a failover of a second NF by the first NF; and based on recognizing the failover of the second NF by the first NF, transmitting information notifying a status of the second NF to an Access and Mobility Management Function (AMF), and the information notifying the status of the second NF may trigger a User Equipment (UE) context release command transmitted to a base station by the AMF.

Additionally, in a non-volatile computer-readable storage medium storing at least one computer program including an instruction enabling at least one processor to perform operations for a first NF when executed by the at least one processor, The operations may include recognizing a failover of a second NF by the first NF; and based on recognizing the failover of the second NF by the first NF, transmitting information notifying a status of the second NF to an Access and Mobility Management Function (AMF), and the information notifying the status of the second NF may trigger a User Equipment (UE) context release command transmitted to a base station by the AMF.

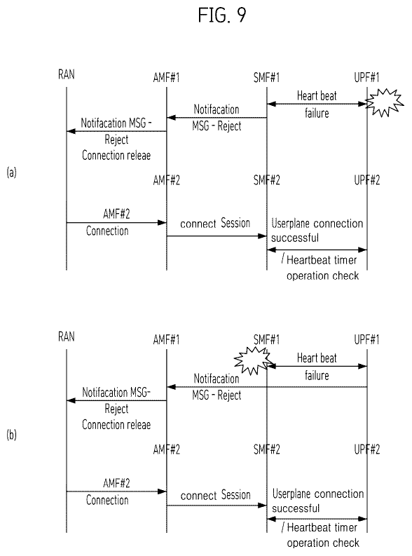

FIG. 9(a) illustrates an embodiment in case of a UPF #1 failover occurrence (failover detection using SMF) in connection with the above description. Referring to FIG. 9(a), SMF #1 recognizes a failover of UPF #1, and the SMF #1 forwards a corresponding failover result to a RAN. A forwarding message may be processed as Reject or a specific parameter value. The RAN receives a corresponding status message and terminates Core #1 connection. Thereafter, the RAN may attempt a connection to Core #2 AMF #2.

FIG. 9(b) illustrates an embodiment in case of an SMF #1 failover occurrence (failover detection using UPF). Specifically, UPF #1 may recognize an SMF #1 failover. The UPF #1 may forward a corresponding failover result to a RAN. A forwarding message may be processed as Reject or a specific parameter value. The RAN may receive a corresponding status message and terminate Core #1 connection. Thereafter, the RAN may attempt a connection to Core #2 AMF #2.

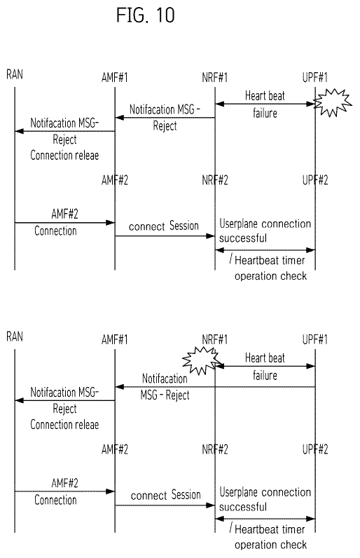

FIG. 10(a) illustrates an embodiment in case of a UPF #1 failover occurrence (failover detection using NRF). The NRF #1 may recognize a failover of the UPF #1 (heartbeat failure recognition scheme). The NRF #1 may notify AMF #1 and then the AMF #1 may forward a corresponding failover result to RAN. A forwarding message may be processed as a reject message, a specific parameter, or a specific notification message. The RAN may receive a corresponding status message and terminate Core #1 connection. Thereafter, the RAN may attempt a connection to Core #2 AMF #2.

FIG. 10(b) illustrates an embodiment in case of an SMF #1 failover occurrence (failover detection using NRF). NRF #1 may recognize an SMF #1 failover (heartbeat failure recognition scheme). The NRF #1 may notify AMF #1 and then the AMF #1 may forward a corresponding failover result to RAN. A forwarding message may be processed as a reject message, a specific parameter, or a specific notification message. The RAN may receive a corresponding status message and terminate Core #1 connection. Thereafter, the RAN may attempt a connection to Core #2 AMF #2.

In the above embodiment, when an SMF/UPF failover occurs in a single configuration, the same CORE N/W may be reconnected. That is, the disclosed contents may relate to an SW failover avoidance technology applicable to both single and redundancy. The above embodiment may be applied in a redundancy/single network structure using its own 5G network (e.g., private 5G) in a factory/hospital or the like.

### Examples of Communication Systems Applicable to the Present Disclosure

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

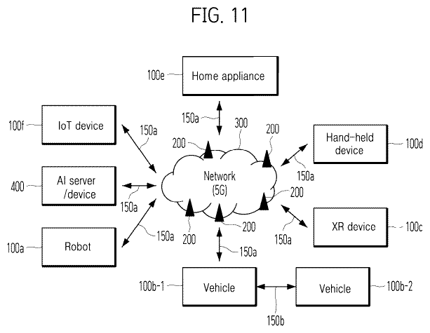

FIG. 11 illustrates a communication system 1 applied to the present disclosure.

Referring to FIG. 11, a communication system 1 applied to the present disclosure includes wireless devices, BSs, and a network. Herein, the wireless devices represent devices performing communication using RAT (e.g., 5G NR or LTE) and may be referred to as communication/radio/5G devices. The wireless devices may include, without being limited to, a robot 100a, vehicles 100b-1 and 100b-2, an extended reality (XR) device 100c, a hand-held device 100d, a home appliance 100e, an Internet of things (IoT) device 100f, and an artificial intelligence (AI) device/server 400. For example, the vehicles may include a vehicle having a wireless communication function, an autonomous driving vehicle, and a vehicle capable of performing communication between vehicles. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. V2V/V2X communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as UL/DL communication 150a, sidelink communication 150b (or, D2D communication), or inter BS communication (e.g. relay, integrated access backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

### Examples of Wireless Devices Applicable to the Present Disclosure

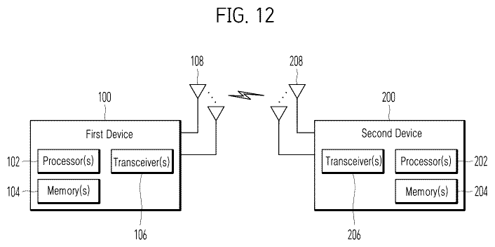

FIG. 12 illustrates wireless devices applicable to the present disclosure.

Referring to FIG. 12, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 11.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more service data unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

### INDUSTRIAL APPLICABILITY

The above-described embodiments may be applied to a redundancy/single network structure that uses its own 5G network (e.g., private 5G) in a factory/hospital, etc.

What is claimed is:

1. A method of operating a first Network Function (NF) related to a failover of a second NF in a wireless communication system, the method comprising:
recognizing the failover of the second NF by the first NF; and
based on the first NF recognizing the failover of the second NF, transmitting information indicating a status of the second NF to an Access and Mobility Management Function (AMF),
wherein the information indicating the status of the second NF triggers a User Equipment (UE) context release command transmitted by the AMF to a base station.

2. The method of claim 1, wherein the first NF recognizes the failover of the second NF based on an ID change of the second NF.

3. The method of claim 2, wherein the ID change of the second NF is caused by a restart based on the failover of the second NF.

4. The method of claim 1, wherein the first NF recognizes the failover of the second NF based on a heartbeat failover of the second NF.

5. The method of claim 4, wherein the heartbeat failure is that a heartbeat from the second NF is not received within a preset time.

6. The method of claim 1, wherein the information indicating the status of the second NF is an NF status notify message.

7. The method of claim 6, wherein the UE context release command is a UE context releases command message.

8. The method of claim 1, wherein the UE context release command triggers an RRC release message of the base station to the UE.

9. The method of claim 8, wherein the UE disconnected from a core network 1 having the AMF belong thereto by the RRC release message transmits a service request for a connection request to the AMF belonging to the core network 1.

10. The method of claim 8, wherein the UE disconnected from a core network 1 having the AMF belong thereto by the RRC release message transmits a service request for a connection request to an AMF belonging to a core network 2.

11. The method of claim 10, wherein the core network 1 and the core network 2 are related to a redundancy network configuration.

12. The method of claim 1, wherein the first NF is a Network Repository Function (NRF) and wherein the second NF is a UPF or an SMF.

13. The method of claim 1, wherein the first NF is a User Plane Function (UPF) and wherein the second NF is a Session Management Function (SMF).

14. The method of claim 1, wherein the first NF is an SMF and wherein the second NF is a UPF.

15. A first Network Function (NF) in a wireless communication system, the first NF comprising:
at least one processor; and
at least one computer memory operatively connected to the at least one processor and storing instructions enabling the at least one processor to perform operations when executed; the operations comprising:
recognizing the failover of the second NF by the first NF; and
based on the first NF recognizing the failover of the second NF, transmitting information indicating a status of the second NF to an Access and Mobility Management Function (AMF),
wherein the information indicating the status of the second NF triggers a User Equipment (UE) context release command transmitted by the AMF to a base station.

16. A non-volatile computer-readable storage medium storing at least one computer program including an instruction enabling at least one processor to perform operations for a first NF when executed, the operations comprising:
recognizing the failover of the second NF by the first NF; and
based on the first NF recognizing the failover of the second NF, transmitting information indicating a status of the second NF to an Access and Mobility Management Function (AMF),
wherein the information indicating the status of the second NF triggers a User Equipment (UE) context release command transmitted by the AMF to a base station.
